(19) United States
(12) Patent Application Publication
(10) Pub. No.: US 2008/0180724 A1
(43) Pub. Date: Jul. 31, 2008

(54) Print driver data logging

(75) Inventor: Senthil K. Selvaraj, Redmond, WA (US)

Correspondence Address: HICKMAN PALERMO TRUONG & BECKER, LLP, 2055 GATEWAY PLACE, SUITE 550, SAN JOSE, CA, 95110, US

(73) Assignee: Ricoh Company Ltd.

(21) Appl. No.: 11/698,545

(22) Filed: Jan. 26, 2007

(51) Int. Cl. G06F 3/12

(52) U.S. Cl. 358/1.15; 358/1.13

(57) ABSTRACT

A print driver is configured with data logging functionality. The data logging functionality includes the ability to generate log data that indicates attributes of print data that has been processed by the print driver. This may include a wide variety of attributes, such as a name of the print data, timestamp data, printing and finishing options and status. Log data may be generated and stored in a variety of formats, depending upon a particular implementation. The print driver may also be configured to generate a graphical user interface for displaying the log data to a user. The print driver may further be configured with an export function to allow the log data to be exported, for example, to other network devices, such as a server. Log data may be exported in a variety of formats and according to various protocols and may include the use of secure communications links or encryption. Including data logging functionality in a print driver as described herein allows users to obtain a history of the print data processed by the print driver.

### FIELD OF THE INVENTION

This invention relates generally to print drivers and more specifically, to a print driver with data logging capability.

### BACKGROUND

The approaches described in this section are approaches that could be pursued, but not necessarily approaches that have been previously conceived or pursued. Therefore, unless otherwise indicated, the approaches described in this section may not be prior art to the claims in this application and are not admitted to be prior art by inclusion in this section.

Generally speaking, print drivers are processes that process print data generated by an application program and convert the print data into a format supported by a printing device that is intended to process the print data. For example, a user creates an electronic document using a word processing application. The user then uses a print option in the application program to request that the electronic document be printed to a particular printing device. The application program generates and provides print data to a print driver installed on the user's client device. Sometimes this involves the use of an intermediary process referred to as a spooler which saves the print data locally. The print driver processes the print data and generates translated print data that is in a format supported by the particular printing device. For example, the print driver may process the print data and generate translated print data that conforms to the postscript format. The print driver then transmits the translated print data to the particular printing device. The particular printing device processes the translated print data and generates a printed version of the electronic document.

Print drivers may reside on client devices, server devices, such as print servers, or even on printing devices. Furthermore, print drivers may be integrated into application programs, but are more typically implemented as separate processes to simplify implementing newer versions.

One of the drawbacks with conventional print drivers is that they do not maintain information about print data that they have processed. When a user wants to know whether an electronic document has been printed, the user has to either physically check the printing device to visually verify whether the electronic document was printed, or query the printing device remotely, for example, via an operating system or printing device utility. For example, a user or administrator may use a print utility application to determine the print jobs that have been, and are currently being, processed by a printer. This approach requires the availability of a print utility application that is capable of obtaining this information from print devices. Furthermore, the printing devices must support this functionality. This approach also does not provide any client-side information about print data that has been processed.

### SUMMARY

A print driver is configured with data logging functionality. The data logging functionality includes the ability to generate log data that indicates attributes of print data that has been processed by the print driver. This may include a wide variety of attributes, such as a name of print data, timestamp data, printing and finishing options and status. Log data may be generated and stored in a variety of formats, depending upon a particular implementation. The print driver may also be configured to generate a graphical user interface for displaying the log data to a user. The print driver may further be configured with an export function to allow the log data to be exported, for example, to other network devices, such as a server. Log data may be exported in a variety of formats and according to various protocols and may include the use of secure communications links or encryption. The approach of including data logging functionality in a print driver as described herein allows users to obtain a client-side history of the print data processed by the print driver.

According to one embodiment of the invention, a print driver includes a rendering module and a logging module. The rendering module is configured to process print data generated by an application program and generate translated print data that conforms to a format supported by a printing device that is intended to process the translated print data. The logging module is configured to generate log data that identifies one or more attributes of print data that has been processed by the print driver.

### BRIEF DESCRIPTION OF THE DRAWINGS

In the figures of the accompanying drawings like reference numerals refer to similar elements.

FIG. 1 is a block diagram that depicts an example arrangement in which print driver data logging may be implemented, according to an embodiment of the invention.

FIG. 2 is an example graphical user interface generated by GUI module.

FIG. 3 is a flow diagram that depicts an approach for implementing print driver data logging according to one embodiment of the invention.

FIG. 4 is a block diagram of a computer system on which embodiments of the invention may be implemented.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention. Various aspects of the invention are described hereinafter in the following sections:

I. OVERVIEW

II. PRINT DRIVER DATA LOGGING ARCHITECTURE

III. PRINT DRIVER DATA LOGGING

IV. LOG DATA SHARING

V. IMPLEMENTATION MECHANISMS

### I. Overview

A print driver is configured with data logging functionality. The data logging functionality includes the ability to generate log data that indicates attributes of print data that has been processed by the print driver. This may include a wide variety of attributes, such as a name of the print data, timestamp data, printing and finishing options and status. Log data may be generated and stored in a variety of formats, depending upon a particular implementation. The print driver may also be configured to generate a graphical user interface for displaying the log data to a user. The print driver may further be configured with an export function to allow the log data to be exported, for example, to other network devices, such as a server. Log data may be exported in a variety of formats and according to various protocols and may include the use of secure communications links or encryption. The approach of including data logging functionality in a print driver as described herein allows users to obtain a history of the print data processed by the print driver.

### II. Print Driver Data Logging Architecture

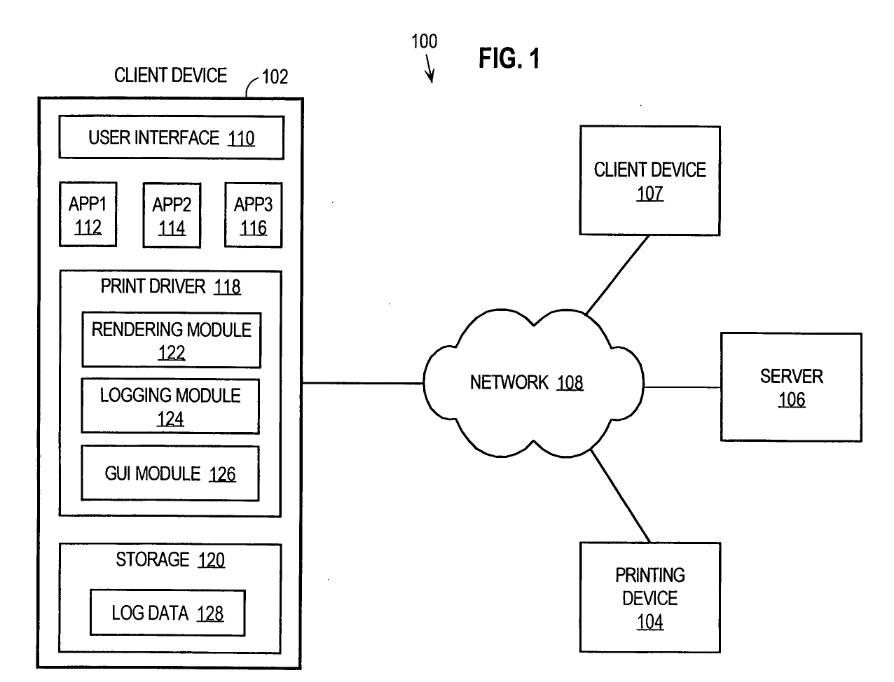

FIG. 1 is a block diagram that depicts an example arrangement 100 in which print driver data logging may be implemented, according to an embodiment of the invention. Arrangement 100 includes a client device 102, a printing device 104, a server 106 and a client device 107 that are communicatively coupled to each other via a network 108. Network 108 may be implemented by any medium or mechanism that provides for the exchange of data between the various elements depicts in FIG. 1. Examples of network 108 include, without limitation, a network such as a Local Area Network (LAN), Wide Area Network (WAN), Ethernet or the Internet, or one or more terrestrial, satellite or wireless links. Network 108 may also provide secure communications between the various elements depicted in FIG. 1. The various elements depicted in FIG. 1 may also communicate with each other via one or more direct communications links that are not depicted in FIG. 1 or described herein for purposes of brevity.

Client devices 102, 107 may be any type of client devices and the invention is not limited to any particular type of client device. Examples of client devices 102, 107 include, without limitation, a desktop computer, a laptop computer, a personal digital assistant (PDA), and a telephony device. In the present example, client device 102 includes a user interface 110, applications APP1 112, APP2 114 and APP3 116, a print driver 118 and storage 120.

User interface 110 may be implemented by any mechanisms and/or processes that allow for the exchange of information between client device 102 and users. Examples of user interface 110 include, without limitation, a display, such as a cathode ray tube (CRT) or liquid crystal display (LCD), and an input device, such as a keypad, touchpad, touch screen, keyboard or mouse, or any combination of displays and input devices.

Applications APP1 112, APP2 114 and APP3 116 may be any type of applications that are capable of generating print data. Examples of applications APP1 112, APP2 114 and APP3 116 include, without limitation, a word processing program, a spreadsheet program, an email program or any other type of application.

Print driver 118 may be implemented by any type of print driver and in any form. For example, print driver 118 may be implemented as one or more software processes. According to one embodiment of the invention, print driver 118 includes a rendering module 122, a logging module 124 and a graphical user interface (GUI) module 126. Print driver 118 may include other modules, elements and functionality not depicted in FIG. 1 or described herein for purposes of brevity, and the invention is not limited to a print driver having any particular combination of modules and functionality. Rendering module 122 processes print data and generates translated print data that conforms to a format supported by an intended recipient printing device. For example, rendering module 122 may process print data generated by a word processing application and generate translated print data that conforms to the postscript format, on the basis that the print data is intended to be processed by printing device 104 and printing device 104 supports postscript. Logging module 124 and GUI module 126 are described in more detail hereinafter.

Storage 120 may be implemented by any type of storage. Examples of storage 120 include, without limitation, volatile memory, such as random access memory (RAM) and non-volatile storage, such as one or more disks or flash memory. Client device 102 may include other mechanisms, modules, processes, etc., depending upon a particular implementation, that are not depicted in FIG. 1 or described herein for purposes of explanation.

### III. Print Driver Data Logging

According to one embodiment of the invention, print driver 118 is configured with logging module 124 that generates log data 128. The log data 128 indicates one or more attributes of print data processed by print driver 118. The attributes may be any type of attributes, depending upon a particular implementation. Example attributes include, without limitation, the name of print data, such as a job name or file name, timestamp information, print data options, such as finishing options including single or double sided printing, number of copies, color or black & white, etc., and status. The log data 128 may indicate attributes for any number of print data processed by print driver 118 and log data 128 may be in any format or structure, depending upon a particular implementation. Example formats include, without limitation, text, rich text and XML. Log data 128 may also be maintained in a secure manner. For example, log data 128 may be stored on storage 120 in an encrypted form. Log data 128 may be stored in compressed form to save storage space.

According to one embodiment of the invention, GUI module 126 is configured to generate a graphical user interface that allows a user to graphically view log data 128. For example, GUI module 126 may be configured to generate one or more instructions and/or GUI objects which, when processed accordingly, provide a GUI for viewing log data 128.

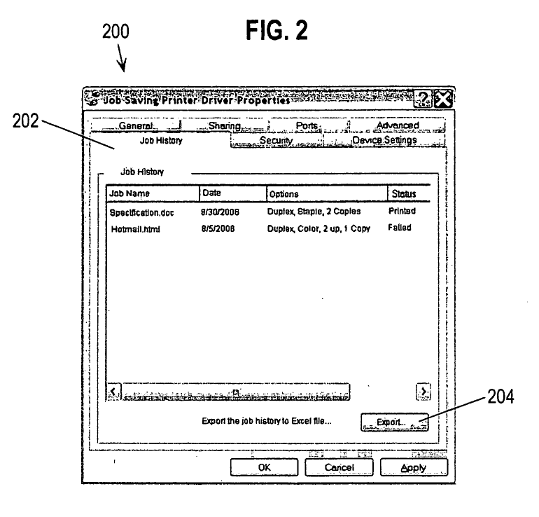

FIG. 2 is an example graphical user interface 200 generated by GUI module 126. The invention is not limited to the example graphical user interface 200, which is provided as merely one example. Graphical user interface 200 may be displayed on user interface 110 in response to a user querying client device 102 for the properties of a particular printing device. In this example, the graphical user interface 200 includes a set of tabs that display different properties of the particular printing device. The tabs include a Job History tab 202 that displays information about print data processed by a print driver for the corresponding printing device. In this example, the Job History tab 202 indicates that the print driver has processed two sets of print data and displays attributes for each set of print data. The attributes include the name of the print data (job name), a date when the print data was processed and options specified by the print data. The options in this example include single or double sided printing (duplex), color or black & white printing, finishing options, such as stapling, and the number of copies. The attributes also include a status, e.g., printed or failed. The options depicted in FIG. 2 are provided as example options for explanation purposes only and the invention is not limited to any particular options or attributes. Job History tab 202 may also include user interface objects that allow a user to enable or disable print driver data logging. For example, Job History tab 202 may include a checkbox to enable print driver data logging. When the checkbox is not checked, then the remaining information displayed on Job History tab 202 may be disable, for example, by being “grayed out”. As another alternative, graphical user interface 200 may include an option for controlling access to log data via a user name and/or a password. For example, graphical user interface 200 may include a checkbox for enabling secure access to log data. When the checkbox is checked, the user is queried for a user name and/or password. Access to view log data 128 then requires the entry of a correct user name and/or password.

### IV. Log Data Sharing

According to one embodiment of the invention, print drivers are configured to allow sharing of log data. This may include the ability to transmit log data to other locations besides storage 120. For example, print driver 118 may be configured to cause log data 128 to be stored to a removable storage device that interfaces with client device 102. Print driver 118 may also be configured to cause log data 128 to be transmitted to other network devices. For example, print driver 118 may be configured to cause log data 128 to be transmitted to client device 107 via network 108. As another example, print driver 118 may be configured to cause log data 128 to be transmitted to server 106. Server 106 may act as a central repository for log data from any number of print drivers on any number of clients. Having log data stored in a central location is very convenient for administrative personnel who wish to view and analyze log data. For example, suppose that a system administrator wants to analyze the performance of a particular printing device. The administrator may access server 106 and view the log data for the particular printing device that was generated at any number of client devices to get an aggregate client-side view of the print data that was processed by multiple print drivers sending print data to the particular printing device.

Print driver 118 may cause log data 128 to be transmitted to other locations in any type of format or structure, depending upon a particular implementation. For example, print driver 118 may be configured to transmit log data 128 as a data file, message or email. Print driver 118 may also be configured to transmit log data 128 in a secure or unsecured format. For example, print driver 118 may be configured to transmit log data 128 using a secure communications channel or in an encrypted form in environments where the log data 128 is considered to contain sensitive information. As another example, log data 128 may be transmitted to server 106 and stored in a secure location on server 106, such as a directory or folder with controlled access. GUI module 126 may be configured to generate a graphical user interface that allows a user to specify a particular form and/or format of log data 128 that is being exported, e.g., data file, message, or email, and may also allow a user to indicate whether the log data 128 should be transmitted using a secure mechanism.

The particular manner in which the sharing of log data is initiated may vary depending upon a particular implementation and the invention is not limited to any particular approach. The graphical user interface 200 of FIG. 2 includes an example user interface object 204 in the form of an Export button which, when selected by a user, initiates the sharing of log data. A user selection of user interface object 204 may cause additional user interface objects to be displayed. For example, one or more user interface objects may be displayed for querying the user for a destination of log data 128. The user interface objects may also allow a user to specify a format or form in which the log data 128 should be transmitted. The user interface objects may also allow a user to specify whether the log data 128 should be transmitted in a secure manner, for example, via a secure communications channel or via encryption.

As an alternative to user-initiated sharing of log data, print driver 118 may also be configured to automatically export log data 128 to other locations. For example, print driver 118 may transmit log data 128 to other locations at specified times or periodic intervals. A user may specify an export schedule via a graphical user interface generated by GUI module 126.

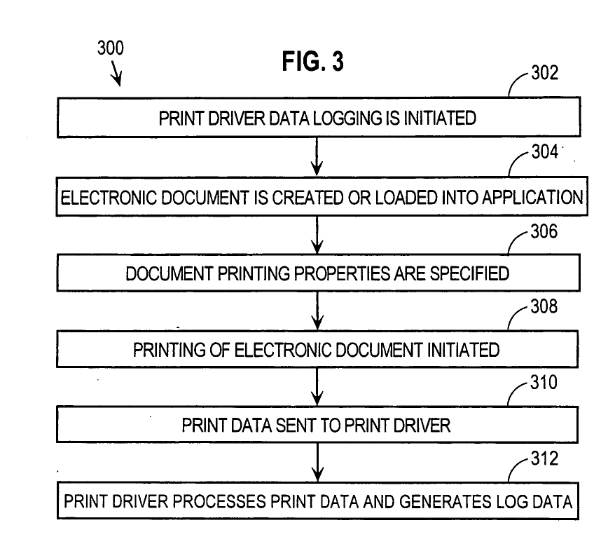

FIG. 3 is a flow diagram 300 that depicts an approach for implementing data logging in a print driver according to one embodiment of the invention. In step 302, print driver data logging is initiated. This may be done, for example, by a user editing the device characteristics for a particular printing device and enabling print driver data logging. In step 304, an electronic document is created or loaded into an application program. For example, a user loads a word processing document into application program APP1 112. In step 306, document printing properties are specified for the electronic document. This may be done, for example, by a user selecting to print the electronic document via the application program APP1 112 and then selecting the properties for the selected printing device. Print driver 118 causes a graphical user interface to be displayed on user interface 110 and the user specifies the desired print properties for the electronic document, such as paper options and finishing options.

In step 308, the user initiates printing of the electronic document and the application program APP1 112 generates print data. In step 310, the print data is sent to the print driver associated with the particular printing device that was selected by the user. This may involve the use of a spooling process. In step 312, the print driver 118 processes the print data and generates the log data 128 as described herein.

### V. Implementation Mechanisms

The print driver with data logging capability may be implemented on any print driver at any location. Although embodiments of the invention have been depicted in the figures and described herein in the context of client-side print driver data logging, the invention is not limited to this context and data logging may be implemented in print drivers implemented on a server. For example, data logging may be implemented in a print driver on a print server. In this situation, the log data may reflect print data processed by the print server that was received from any number of client devices.

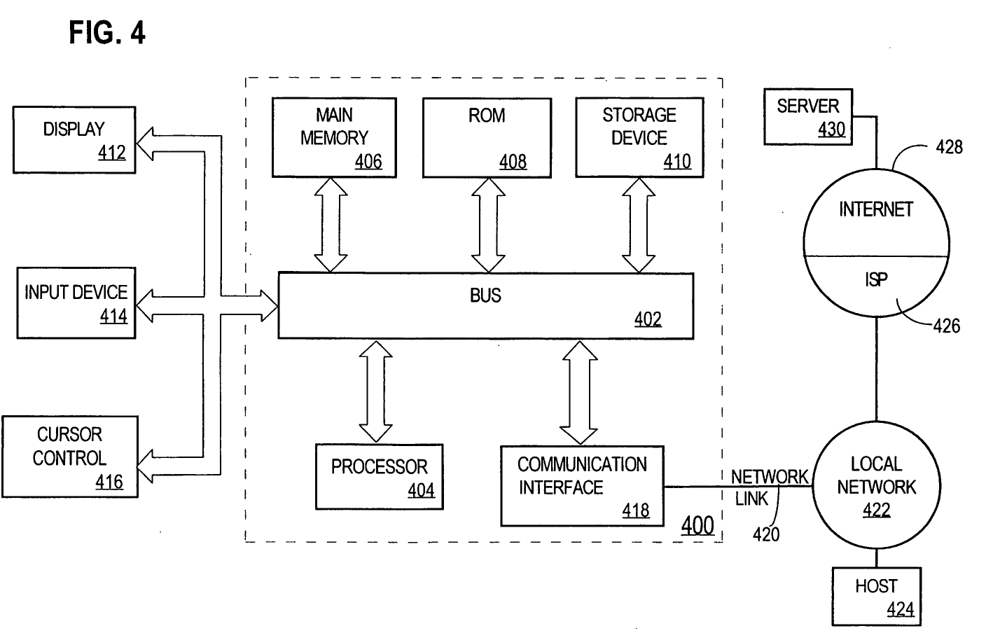

The print driver with data logging capability may be implemented on any type of computing platform or architecture. FIG. 4 is a block diagram that illustrates an example computer system 400 upon which an embodiment of the invention may be implemented. Computer system 400 includes a bus 402 or other communication mechanism for communicating information, and a processor 404 coupled with bus 402 for processing information. Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

The invention is related to the use of computer system 400 for implementing the techniques described herein. According to one embodiment of the invention, those techniques are performed by computer system 400 in response to processor 404 executing one or more sequences of one or more instructions contained in main memory 406. Such instructions may be read into main memory 406 from another machine-readable medium, such as storage device 410. Execution of the sequences of instructions contained in main memory 406 causes processor 404 to perform the process steps described herein. In alternative embodiments, hard-wired circuitry may be used in place of or in combination with software instructions to implement the invention. Thus, embodiments of the invention are not limited to any specific combination of hardware circuitry and software.

The term “machine-readable medium” as used herein refers to any medium that participates in providing data that causes a machine to operation in a specific fashion. In an embodiment implemented using computer system 400, various machine-readable media are involved, for example, in providing instructions to processor 404 for execution. Such a medium may take many forms, including but not limited to, non-volatile media, volatile media, and transmission media. Non-volatile media includes, for example, optical or magnetic disks, such as storage device 410. Volatile media includes dynamic memory, such as main memory 406. Transmission media includes coaxial cables, copper wire and fiber optics, including the wires that comprise bus 402. Transmission media can also take the form of acoustic or light waves, such as those generated during radio-wave and infra-red data communications.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 404 for execution. For example, the instructions may initially be carried on a magnetic disk of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are exemplary forms of carrier waves transporting the information.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418. The received code may be executed by processor 404 as it is received, and/or stored in storage device 410, or other non-volatile storage for later execution. In this manner, computer system 400 may obtain application code in the form of a carrier wave.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A print driver comprising:
a rendering module configured to process print data generated by an application program and generate translated print data that conforms to a format supported by a printing device that is intended to process the translated print data; and
a logging module configured to generate log data that identifies one or more attributes of print data that has been processed by the print driver.

2. The print driver recited in claim 1, wherein the print driver is further configured to cause the log data to be transmitted over a communications network to a network node other than where the print driver is executing.

3. The print driver recited in claim 1, wherein the print driver is further configured to cause the log data to be transmitted over a communications network to a server.

4. The print driver recited in claim 3, further comprising a graphical user interface module configured to generate graphical user interface data, wherein processing of the graphical user interface data at the client allows a user to cause the log data to be transmitted over a communications network to a server.

5. The print driver recited in claim 1, further comprising a graphical user interface module configured to generate graphical user interface data, wherein processing of the graphical user interface data at the client allows a user to view the log data in a graphical form on a user interface.

6. The print driver recited in claim 5, wherein the graphical user interface module is further configured to generate the graphical user interface data in a manner such that processing of the graphical user interface data at the client requires a user to enter password data before the user is allowed to view the log data in the graphical form on the user interface.

7. The print driver recited in claim 1, wherein the one or more attributes of the print data include one or more of a name associated with the print data, a timestamp indicating when the print data was processed, one or more finishing options, or a status of the processing of the print data.

8. A computer-implemented method for processing print data generated by an application program, the computer-implemented method comprising:
at a print driver, processing print data generated by an application program and generating translated print data that conforms to a format supported by a printing device that is intended to process the translated print data; and
at the print driver, generating log data that identifies one or more attributes of print data that has been processed by the print driver.

9. The computer-implemented method recited in claim 8, further comprising at the print driver causing the log data to be transmitted over a communications network to a network node other than where the print driver is executing.

10. The computer-implemented method recited in claim 8, further comprising at the print driver causing the log data to be transmitted over a communications network to a server.

11. The computer-implemented method recited in claim 10, further comprising at the print driver generating graphical user interface data, wherein processing of the graphical user interface data at the client allows a user to cause the log data to be transmitted over a communications network to a server.

12. The computer-implemented method recited in claim 8, further comprising at the print driver generating graphical user interface data, wherein processing of the graphical user interface data at the client allows a user to view the log data in a graphical form on a user interface.

13. The computer-implemented method recited in claim 12, further comprising at the print driver generating the graphical user interface data in a manner such that processing of the graphical user interface data at the client requires a user to enter password data before the user is allowed to view the log data in the graphical form on the user interface.

14. The computer-implemented method recited in claim 8, wherein the one or more attributes of the print data include one or more of a name associated with the print data, a timestamp indicating when the print data was processed, one or more finishing options, or a status of the processing of the print data.

15. A computer-readable medium for processing print data generated by an application program, the computer-readable medium carrying instructions which, when processed by one or more processors, cause:
at a print driver, processing print data generated by an application program and generating translated print data that conforms to a format supported by a printing device that is intended to process the translated print data; and
at the print driver, generating log data that identifies one or more attributes of print data that has been processed by the print driver.

16. The computer-readable medium recited in claim 15, further comprising additional instructions which, when processed by the one or more processors, cause the log data to be transmitted over a communications network to a network node other than where the print driver is executing.

17. The computer-readable medium recited in claim 15, further comprising additional instructions which, when processed by the one or more processors, cause the log data to be transmitted over a communications network to a server.

18. The computer-readable medium recited in claim 17, further comprising additional instructions which, when processed by the one or more processors, cause generating graphical user interface data, wherein processing of the graphical user interface data at the client allows a user to cause the log data to be transmitted over a communications network to a server.

19. The computer-readable medium recited in claim 15, further comprising additional instructions which, when processed by the one or more processors, cause generating graphical user interface data, wherein processing of the graphical user interface data at the client allows a user to view the log data in a graphical form on a user interface.

20. The computer-readable medium recited in claim 19, further comprising additional instructions which, when processed by the one or more processors, cause generating the graphical user interface data in a manner such that processing of the graphical user interface data at the client requires a user to enter password data before the user is allowed to view the log data in the graphical form on the user interface.

21. The computer-readable medium recited in claim 15, wherein the one or more attributes of the print data include one or more of a name associated with the print data, a timestamp indicating when the print data was processed, one or more finishing options, or a status of the processing of the print data.
